(19) United States
(12) Patent Application Publication
(10) Pub. No.: US 2023/0291049 A1
(43) Pub. Date: Sep. 14, 2023

(54) CORDLESS POWER TOOL SYSTEM

(71) Applicant: BLACK & DECKER INC., New Britain, CT (US)

(72) Inventors: Michael VARIPATIS, Fallston, MD (US); Franklin REGAN, Columbia, MD (US)

(21) Appl. No.: 18/114,121

(22) Filed: Feb. 24, 2023

Related U.S. Application Data
(60) Provisional application No. 63/268,451, filed on Feb. 24, 2022.

(51) Int. Cl. H01M 50/244; H01M 50/247

(52) U.S. Cl. CPC H01M 50/244; H01M 50/247; H01M 2220/30

(57) ABSTRACT

The present disclosure is directed to a power tool system including at least a first power tool and a second power tool wherein the first power tool and the second power tool have distinct interfaces for mating with a removable, rechargeable battery pack and a first battery pack having a first interface to mate with the first power tool and a second battery pack having a second interface to mate with the second power tool. The second battery pack does not mate with the first power tool and the first battery pack does not mate with the second power tool. The system furth includes an adaptor to enable the first battery pack to operate with the second power tool.

### RELATED APPLICATIONS

This application claims priority under 35 U.S.C. § 119(e) to U.S. Provisional Patent Application No. 63/268,451, filed Feb. 24, 2023, titled “Cordless Power Tool System.”

### TECHNICAL FIELD

This application relates to a cordless power tool system. In one implementation, the cordless power tool system includes a plurality of sets of cordless power tools and a plurality of sets of battery packs, a plurality of sets of battery pack chargers, and a plurality of adaptors for enabling a first cordless power tool with a first interface to operate with a battery pack configured and designed to operate with a second, different interface of a second power tool.

### BACKGROUND

A battery pack platform is designed around a common interface including a set of terminals, a set of rails, and a latch. It is desirable to preserve operability between a first, distinct set of products (power tools, battery packs, and battery pack chargers) having a first distinct interface and a second, distinct set of products (power tools, battery packs, and battery pack chargers) having a second distinct interface that is functionally different than the first interface.

As tools are developed that demand higher currents and longer runtimes, larger and more powerful packs must also be developed. A crucial feature of the higher power tools and battery packs is to preserve compatibility and operability across the platform where it is needed while preserving the ergonomics of the tools.

A distinct interface - including (1) a distinct power tool portion of the interface and (2) a corresponding distinct battery pack portion of the interface must be developed. The power tool portion of the interface is configured to mate with the battery pack portion of the interface.

Cordless power tools require a source of energy to operate. Typically, removable, rechargeable battery packs serve as this source of energy. The power tool and battery pack are designed and configured with an interface to enable the power tool and the battery pack to mate (couple) together. The tool/pack interface may be generally referred to simply as an interface. The interface may include a tool portion that is part of the power tool (sometimes referred to as a pack interface) and may include a battery pack portion that is part of the battery pack (sometimes referred to as a tool interface). As is well known, the interface may include a set of rails and grooves and a catch on the power tool and a corresponding set of rails and grooves and a latch on the battery pack.

The interface for a family or set of power tools and battery packs is unique to that family. In other words, a battery pack from a first power tool system will not mate with a power tool of a second power tool system and a power tool from the first power tool system will not mate with a battery pack of the second power tool system.

The instant application describes example sets of power tools and example sets of battery packs and example sets of adaptor to enable a battery from the first power tool system to operate with a power tool from the second power tool system and a power tool from the first power tool system to operate with a battery pack from the second power tool system.

### SUMMARY

An aspect of the present invention includes an adaptor for enabling a battery pack having an interface portion that is not compatible with an interface portion of a power tool to operate with the power tool.

Another aspect of the present invention includes an adaptor for enabling two battery packs, each having an interface portion that is not compatible with an interface portion of a power tool to operate with the power tool.

These and other advantages and features will be apparent from the description and the drawings.

### BRIEF DESCRIPTION OF THE DRAWINGS

FIG. 1 illustrates an example power tool representative of a first set of power tools.

FIG. 2 illustrates an example power tool representative of a second set of power tools.

FIG. 3 illustrates an example power tool representative of a third set of power tools.

FIG. 4 illustrates an example battery pack representative of a first set of battery packs.

FIG. 5 illustrates an example battery pack representative of a second set of battery packs.

FIG. 6 illustrates an example battery pack representative of a third set of battery packs.

FIG. 7 illustrates an example battery pack charger representative of a first set of battery pack chargers.

FIGS. 8A-8N illustrate example power tools representative of a fourth set of power tools.

FIGS. 9A, 94B, 94C illustrate an example battery pack representative of a fourth set of battery packs.

FIGS. 10A and 10B illustrate an example battery pack adaptor of a first set of battery pack adaptors.

FIGS. 11A and 11B illustrate an example battery pack adaptor of a second set of battery pack adaptors.

FIG. 12 illustrates the example battery pack of FIG. 6 and the example battery pack adaptor of FIG. 10.

FIG. 13 illustrates two example battery packs of FIG. 6 and the example battery pack adaptor of FIG. 11.

FIGS. 14A, 14B, and 14C illustrate various views of the example battery pack of FIG. 9, the example battery pack and adaptor of FIG. 12, and the example battery packs and adaptor of FIG. 13.

FIG. 15 illustrates another view of the example battery pack of FIG. 9, the example battery pack and adaptor of FIG. 12, and the example battery packs and adaptor of FIG. 13.

FIGS. 16A and 16B illustrate another view of the example battery pack of FIG. 9, the example battery pack and adaptor of FIG. 12, and the example battery packs and adaptor of FIG. 13.

FIG. 17 illustrates an isometric view of the example battery pack and adaptor of FIG. 12 with a portion of a housing of the adaptor removed.

FIG. 18 illustrates a detail view of FIG. 1.

FIG. 19 illustrates an isometric view of the example battery packs and adaptor of FIG. 13 with a portion of a housing of the adaptor removed.

FIG. 20 illustrates the example battery pack of FIG. 9 just prior to mating with or just after unmating with another example power tool of the fourth set of power tools.

FIG. 21 illustrates the example battery pack of FIG. 9 mated to another example power tool of the fourth set of power tools.

FIG. 22 illustrates the example adaptor of FIG. 10 just prior to mating with or just after unmating with the example power tool of FIG. 20.

FIG. 23 illustrates the example adaptor of FIG. 10 mated to the example power tool of FIG. 21.

FIG. 24 illustrates the example adaptor of FIG. 11 just prior to mating with or just after unmating with the example power tool of FIG. 20.

FIG. 25 illustrates the example adaptor of FIG. 118 mated to the example power tool of FIG. 21.

FIG. 26 illustrates the example battery pack of FIG. 94 just prior to mating with or just after unmating with an example battery pack charger representative of a second set of battery pack chargers.

FIG. 27 illustrates the example battery pack of FIG. 9 mated to the example battery pack charger of FIG. 26.

FIG. 28 illustrates the example battery pack of FIG. 9 just prior to mating with an example battery pack charger representative of a third set of battery pack chargers.

FIGS. 29A, 29B, and 29C illustrate an example adaptor representative of a third set of adaptors.

FIG. 30 illustrates the example adaptor of FIG. 29 just prior to mating with the example battery pack charger of FIG. 7.

FIG. 31 illustrates the example adaptor of FIG. 29 mated to the example battery pack charger of FIG. 7.

FIG. 32 illustrates an example battery pack charging system including the example battery pack charger of FIG. 7, the example adaptor of FIG. 29, the example battery pack of FIG. 9, and the example battery pack and adaptor of FIG. 12.

FIG. 33 illustrates an example power tool system including the example power tool of FIG. 2, the example power tool of FIG. 3, the example adaptor of FIG. 29, the example battery pack of FIG. 9 and the example battery pack and adaptor of FIG. 12.

FIGS. 34A, 34B, and 34C illustrate an example battery pack charger representative of a fourth set of battery pack chargers.

FIG. 35 illustrates an example battery pack charging system including the example battery pack charger of FIG. 34, the example battery pack of FIG. 4, the example battery pack of FIG. 5, the example battery pack of FIG. 6, the example battery pack of FIG. 9, and the example battery pack and adaptor of FIG. 12.

FIG. 36 illustrates the example battery pack of FIG. 9 just prior to mating with an example battery pack charger representative of a fifth set of battery pack chargers which is configured to mate with an electric vehicle charging station.

FIG. 37 illustrates another example power tool system including the example battery pack of FIG. 9, the example adaptor of FIG. 12, the example adaptor of FIG. 13, an example backpack adaptor representative of another set of adaptors and an example set of cordless power tools.

FIG. 38 illustrates a plurality of example battery packs of FIG. 9 and the example jobsite buggy of FIG. 8N.

FIG. 39 illustrates another example power tool system including an example first type of battery pack and example battery pack adaptors combined with an example second type of battery pack and example power tools that operate with the example first type of battery pack and the example adaptors combined with the example second type of battery pack.

FIGS. 40A, 40B, and 40C illustrate another example power tool system including an example first type of battery pack, example battery pack adaptors combined with an example second type of battery pack and an example power tool that operates with the example first type of battery pack and the example adaptors combined with the example second type of battery pack.

FIGS. 41A, 41B, and 41C illustrate another example power tool system including an example first type of battery pack, an example adaptor combined with an example second type of battery pack and an example power tool that operates with the example first type of battery pack and the example adaptor combined with the example second type of battery pack.

### DETAILED DESCRIPTION

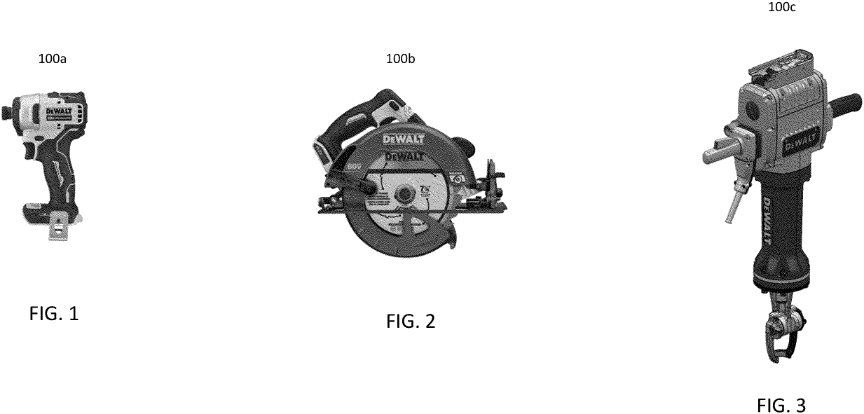

Referring to FIGS. 1-11 there is illustrated an example power tool system which may include example sets of power tools, example sets of battery packs, example sets of battery pack chargers, and example sets of battery pack adaptors. As shown in FIG. 1, there is an example power tool that is representative of a first set or plurality of power tools. The terminology “the power tool of the first set of power tools” and “the first set of power tools” may be used interchangeably and also referred to herein as “the first power tool” with the reference number 100a. The first power tool 100a may have a first, relatively low operating voltage (e.g., 18 volts, sometimes referenced as 20 V or 20 V Max in the marketplace).

As shown in FIG. 2, there is an example power tool that is representative of a second set or plurality of power tools. The terminology “the power tool of the second set of power tools” and “the second set of power tools” may be used interchangeably and also referred to herein as “the second power tool” with the reference number 100b. The second power tool 100b may have a second, relatively high operating voltage (e.g., 54 volts, sometimes referenced as 60V or 60V Max in the marketplace).

As shown in FIG. 3, there is an example power tool that is representative of a third set or plurality of power tools. The terminology “the power tool of the third set of power tools” and “the third set of power tools” may be used interchangeably and also referred to herein as “the third power tool” with the reference number 100c. The third power tool 100c may also have the second, relatively high operating voltage (e.g., 54 volts, sometimes referenced as 60V or 60V Max in the marketplace). A difference between the second power tool 100b and the third power tool 100c may be an amount of power required for operation of the tool, during the normal course of operation of the tool. For example, the second tool 100b may have lower power requirements than the third power tool 100c. Other differences between the second power tool 100b and the third power tool 100c will be discussed below.

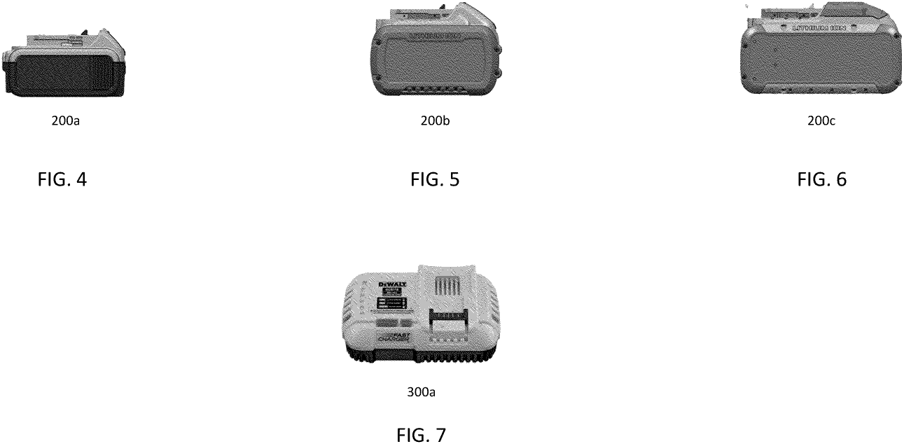

As shown in FIG. 4, there is an example battery pack that is representative of a first set or plurality of battery packs. The terminology “the battery pack of the first set of battery packs” and “the first set of battery packs” may be used interchangeably and also referred to herein as ‘the first battery pack” with the reference number 200a. The first battery pack 200a may be a single, fixed voltage battery pack and may have a first, relatively low rated (nominal) voltage (e.g., 18 volts, sometimes referenced as 20V or 20V Max in the marketplace) that matches the operating voltage of the first power tool 100a.

As shown in FIG. 5, there is an example battery pack that is representative of a second set or plurality of battery packs. The terminology “the battery pack of the second set of battery packs” and “the second set of battery packs” may be used interchangeably and also referred to herein as “the second battery pack” with the reference number 200b. The second battery pack 200b may be a multi-voltage capable battery pack capable of providing the relatively low rated voltage when in a first mode or state that matches the operating voltage of the first power tool 100a or a relatively high rated voltage when in a second mode or state that matches the operating voltage of the second power tool 100b and the third power tool 100c. Such a battery pack is disclosed and described, for example, in U.S. Patent No. 9,406,915, which is hereby incorporated by reference.

As shown in FIG. 6, there is an example battery pack that is representative of a third set or plurality of battery packs. The terminology “the battery pack of the third set of battery packs” and “the third set of battery packs” may be used interchangeably and also referred to herein as “the third battery pack” with the reference number 200c. The third battery pack 200c may also be a multi-voltage capable battery pack capable of providing the relatively low rated voltage when in a first mode or state that matches the operating voltage of the first power tool 100a or the relatively high rated voltage when in a second mode or state that matches the operating voltage of the second power tool 100b and the third power tool 100c. Such a battery pack is disclosed and described, for example, in U.S. Patent No. 9,406,915 and/or U.S. Patent Application Publication No. 2022-0013842-A1, which are hereby incorporated by reference. A difference between the second battery pack 200b and the third battery pack 200c may be an amount of power available to output from the battery pack, during the normal course of operation of the battery pack. For example, the second battery pack 200b may have less power available than the third battery pack 200c. Other differences between the second battery pack 200b and the third battery pack 200c will be discussed below.

As shown in FIG. 7, there is an example battery pack charger (sometimes simply referred to as a charger) that is representative of a first set or plurality of battery pack chargers. The terminology “the battery pack charger of the first set of battery pack chargers” and “the first set of battery pack chargers” may be used interchangeably and also referred to herein as “the first battery pack charger” with the reference number 300a. The battery pack charger 300a may charge the first battery pack 200a, the second battery pack 200b and/or the third battery pack 200c to its rated voltage. The first charger 300a may include a battery pack charger portion of the first interface (sometimes referred to as first (1^{st}) pack interface.

There is a first interface that enables the first power tool 100a to mate and operate with the first battery pack 200a. The first power tool 100a includes a power tool portion of the first interface (sometimes referred to as a first (1^{st}) pack interface) and the first battery pack 200a includes a battery pack portion of the first interface (sometimes referred to as first (1^{st}) tool interface).

There is a second interface that enables the second battery pack 200b to mate and operate with (1) the second power tool 100b - when the second battery pack 200b is in the second mode and (2) the first power tool 100a - when the second battery pack 200b is in the first mode. The second power tool 100b includes a power tool portion of the second interface (sometimes referred to as the second (2^{nd}) pack interface and the second battery pack 200b includes a battery pack portion of the second interface (sometimes referred to as the second (2^{nd}) tool interface). The first interface and the second interface have some features in common.

There is a third interface that enables the third battery pack 200c to mate and operate with (1) the second power tool 100b and/or the third power tool 100c - when the third battery pack 200c is in the second mode and (2) the first power tool 100a - when the third battery pack 200c is in the first mode. The third power tool 100c includes a power tool portion of the third interface (sometimes referred to as the third (3^{rd}) pack interface) and the third battery pack 200c includes a battery pack portion of the third interface (sometimes referred to as the third (3^{rd}) tool interface). The second interface and the third interface have some features in common.

The third power tool 100c may require a greater amount of power or runtime than the second power tool 100b and the second power tool 100b may require a greater amount of power or runtime than the first power tool 100a. The first, second and third power tools 100a, 100b, 100c may require a relatively low amount of power or runtime than other tools, described in more detail below - as such, these power tools may be referred to as low power tools.

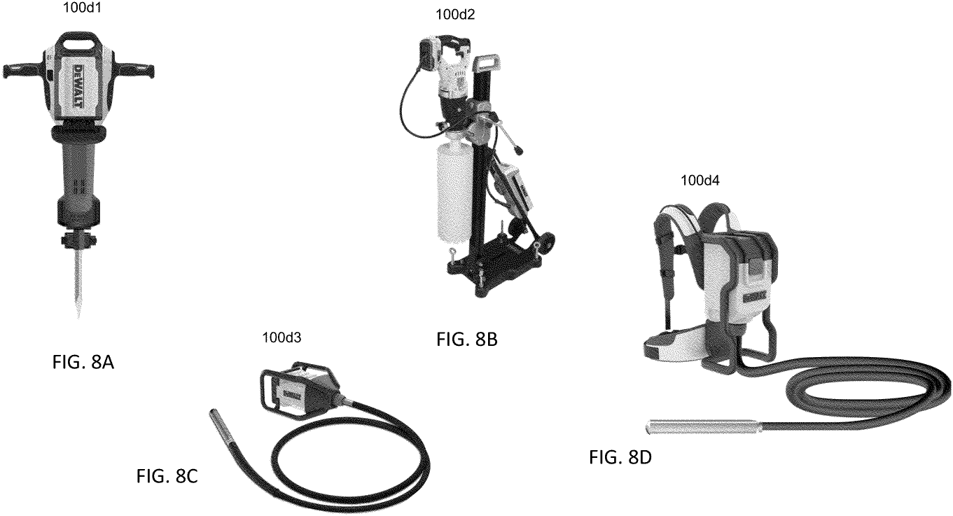

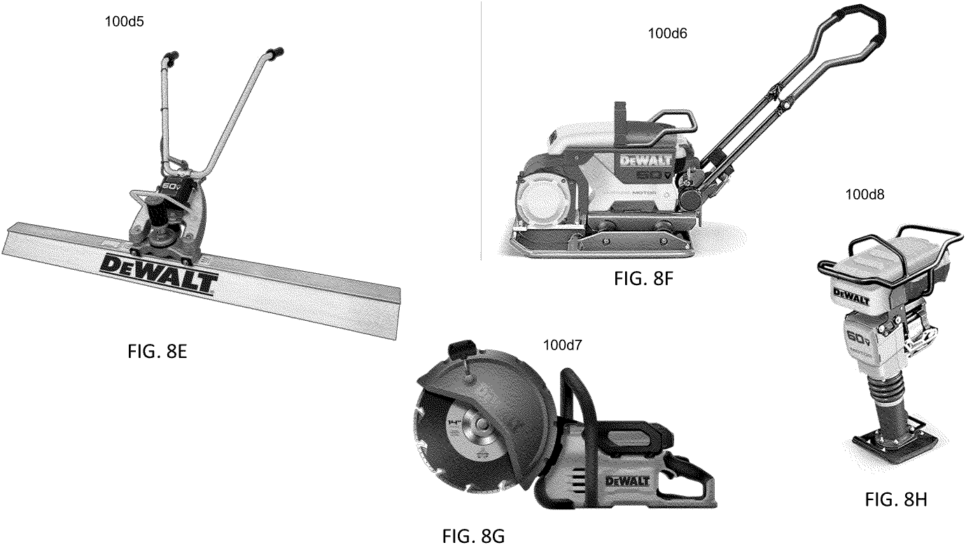

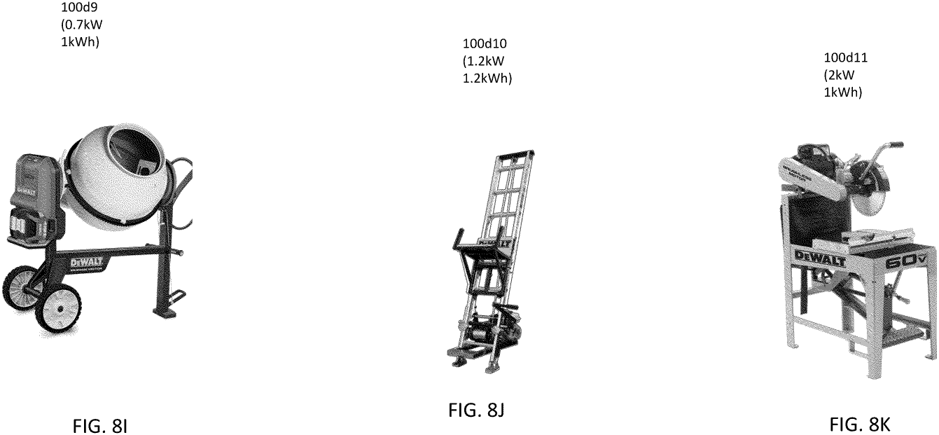

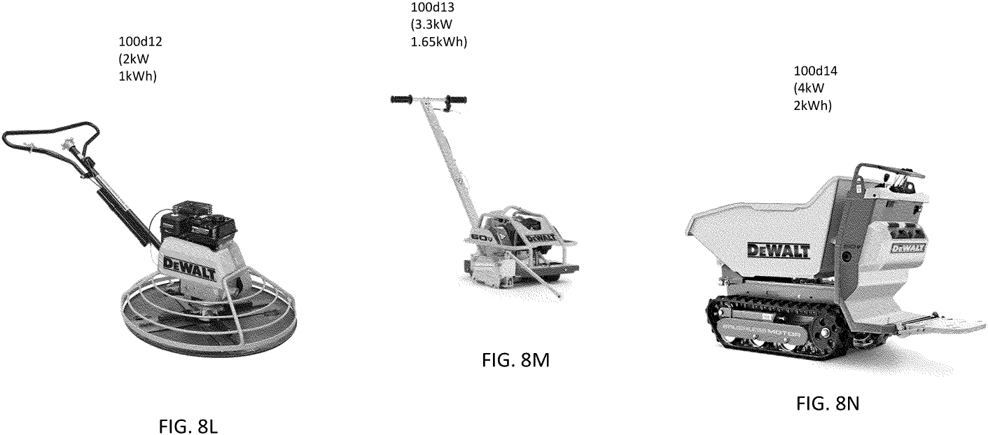

FIGS. 8A-8H illustrate a first group of example power tools that are representative of a fourth set or plurality of power tools. The terminology “the power tool of the fourth set of power tools” and “the fourth set of power tools” may be used interchangeably and also referred to herein as “the fourth power tool” with the reference number 100d. The fourth power tool 100d may have the second, relatively high operating voltage (e.g., 54 volts, sometimes referenced as 60V or 60V Max in the marketplace). The first group of the fourth set of power tools 100a may include but are not limited to a jackhammer 100d1, a core drill 100d2, a power pack vibrator 100d3, a backpack vibrator 100d4, a screed 100d5, a plate compactor 100d6, a 12″ cut-off saw 100d7, and a rammer 100d8. This first group 100d1-100d8 of the fourth power tools 100d may require a relatively high amount of power and/or runtime compared to the third power tool 100c - as such, these power tools 100d1-100d8 may be referred to as high power tools.

FIGS. 8I-8N illustrates a second group of example power tools that are representative of the fourth set of power tools. The second group of the fourth set of power tools 100a may include but is not limited to a concrete mixer 100d9, a jobsite lift 100d10, a block saw 100d11, a concrete finisher 100d12, an early entry saw 11d13, and a jobsite buggy 100d14. This second group of the fourth power tools 100d may have the relatively high operating voltage. The second group 100d9-100d14 of the set of fourth power tools 100d may require a relatively high amount of power and/or runtime compared to the first group 100d1-100d8 of the fourth set of power tools 100d. As such, the second group 100d9-100d14 of the fourth set of power tools 100d may be referred to as very high power tools.

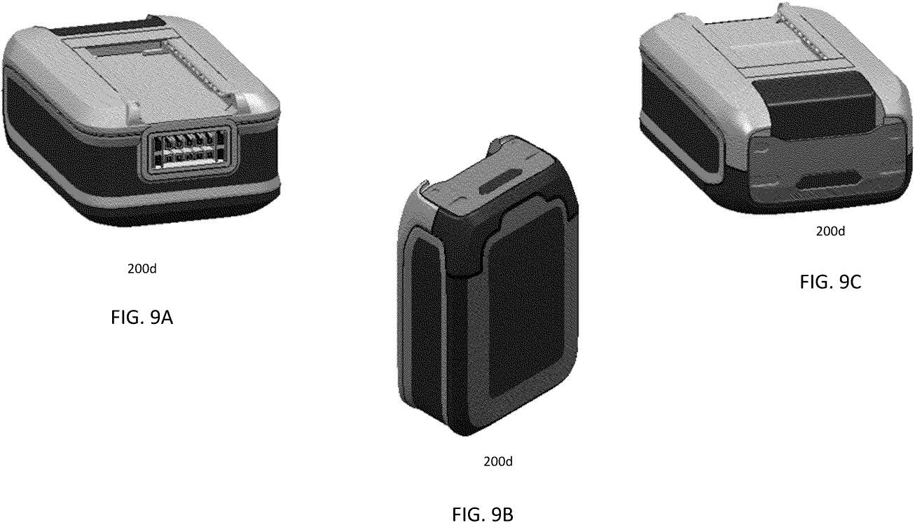

FIGS. 9A, 9B, and 9C illustrate an example battery pack that is representative of a fourth set or plurality of battery packs. The terminology “the battery pack of the fourth set of battery packs” and “the fourth set of battery packs” may be used interchangeably and also referred to herein as “the fourth battery pack” with the reference number 200d. The fourth battery pack 200d may be a single, fixed voltage battery pack and may have the second, relatively high rated (nominal) voltage (e.g., 54 volts, sometimes referenced as 60V or 60V Max in the marketplace) that matches the operating voltage of the fourth power tool 100d.

There is a fourth interface that enables the fourth power tool 100d to mate and operate with the fourth battery pack 200d. The fourth power tool 100d includes a power tool portion of the fourth interface (sometimes referred to as fourth (4^{th}) pack interface) and the fourth battery pack 200d includes a battery pack portion of the fourth interface (sometimes referred to as fourth (4^{th}) tool interface). As illustrated in FIGS. 9A-9C, the battery pack portion of the fourth interface may include a terminal block, a set of rails, a set of grooves, and a latch. The battery pack portion of the fourth interface being designed and configured to mechanically and electrically mate with the power tool portion of the fourth interface.

Even though (1) the second power tool 100b and the third power tool 100c operate at the relatively high operating voltage (e.g., 60V) and (2) the second battery pack 200b and the third battery pack 200c may provide the relatively high voltage (e.g., 60V) and (3) the second power tool 100b and the third power tool 100c may mate and operate with the second battery pack 200b and/or the third battery pack 200c and even though the fourth power tool 100d operates at the same relatively high operating voltage (e.g., 60V) as the second power tool 100c and the third power tool 100c and the fourth battery pack 200d may provide the same relatively high voltage (e.g., 60V) and the fourth power tool 100d may mate and operate with the fourth battery pack 200d, the fourth interface is sufficiently distinct enough from the second interface and third interface that the second power tool 100b and the third power tool 100c will not mate and operate with the fourth battery pack 200d and the fourth power tool 100d will not mate and operate with the second battery pack 200b and/or the third battery pack 200c.

As illustrated in FIGS. 9A, 9B and 9C, the fourth battery pack 200d includes a housing, and a handle, and the battery pack portion of the fourth interface. The battery pack portion of the fourth interface may include a terminal block, a set of rails, a set of grooves and a latch. The terminal block may include a terminal block housing including a plurality of openings or cavities or slots and a plurality of terminals held in place relative to each other and received in individual openings. The battery pack portion of the fourth interface is configured to mate with the power tool portion of the fourth interface.

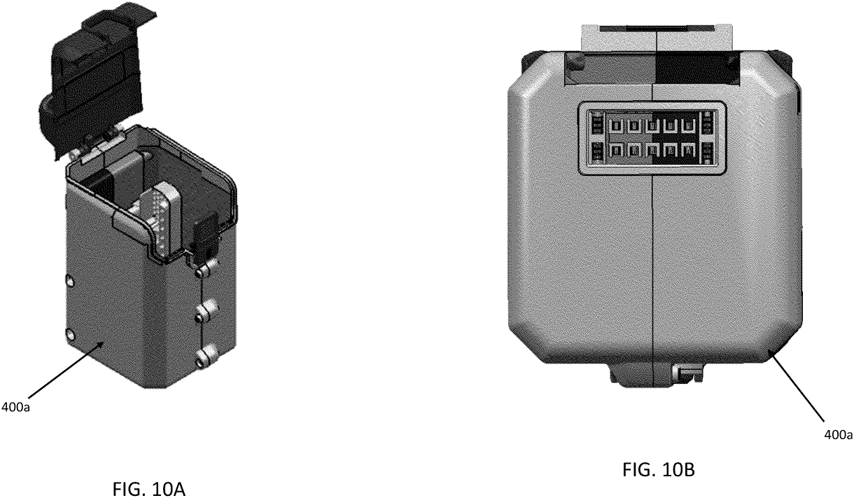

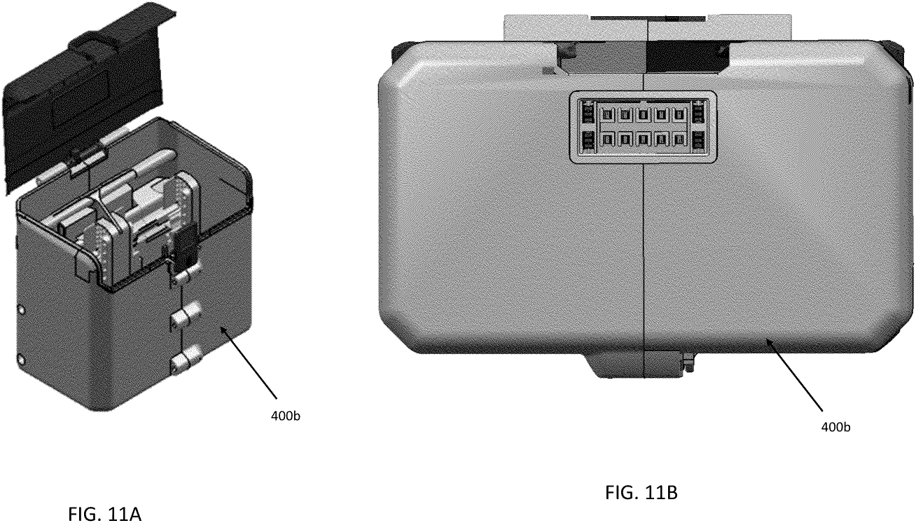

In order to enable the third battery pack 200c to operate with the fourth power tool 100d, the system requires a battery pack adaptor 400. As shown in FIGS. 10A and 10B, there is an example battery pack adaptor (sometimes simply referred to as an adaptor) that is representative of a first set or plurality of battery pack adaptors. The terminology “the battery pack adaptor of the first set of battery pack adaptors” and “the first set of battery pack adaptors” may be used interchangeably and also referred to herein as “the first battery pack adaptor” with the reference number 400a. The first battery pack adaptor 400a may include a housing including a receptacle or port for receiving and mating with a single third battery pack 200c. The first battery pack adaptor 400a may include portions of two distinct interfaces: a power tool portion of the third interface and a battery pack portion of the fourth interface. In the illustrated example embodiment, the first battery pack adaptor 400a includes a cavity that includes the receptacle or port. Within the cavity, the first battery pack adaptor 400a may include an equivalent of the power tool portion of the third interface. This adaptor power tool portion of the third interface may include a set of rails, a set of grooves, a terminal block and a catch. This adaptor power tool portion of the third interface is designed and configured to mechanically and electrically mate with (1) the battery pack portion of the second interface and/or (2) the battery pack portion of the third interface. On an outside of the adaptor housing, the first battery pack adaptor 400a may include an equivalent of the battery pack portion of the fourth interface. This adaptor battery pack portion of the fourth interface may include a set of rails, a set of grooves, a terminal block and a latch. This adaptor battery pack portion of the fourth interface is designed and configured to mechanically and electrically mate with the power tool portion of the fourth interface. The first battery pack adaptor 400a may also include a lid or cap or door that encloses the second battery pack 200b or the third battery pack 200c within the first battery pack adaptor 400a. The housing and lid (when closed) may seal the third battery pack 200c from the environment outside the first battery pack adaptor 400a. This will protect the third battery pack 200c from debris and other contaminants, such as water.

As shown in FIGS. 11A and 11B, there is another example battery pack adaptor that is representative of a second set or plurality of battery pack adaptors. The terminology “the battery pack adaptor of the second set of battery pack adaptors” and “the second set of battery pack adaptors” may be used interchangeably and also referred to herein as “the second battery pack adaptor” with the reference number 400b. The second battery pack adaptor 400b may include a housing including a receptacle or port for receiving and mating with two of the second battery packs 200b or two of the third battery packs 200c. The second battery pack adaptor 400b may include portions of two distinct interfaces: a power tool portion of the third interface and a battery pack portion of the fourth interface. In the illustrated example embodiment, the second battery pack adaptor 400b includes a cavity that includes two receptacles or ports. Within the cavity, the second battery pack adaptor 400b may include an equivalent of two of the power tool portion of the third interface. Each of the adaptor power tool portions of the third interface may include a set of rails, a set of grooves, a terminal block and a catch. This adaptor power tool portion of the third interface is designed and configured to mechanically and electrically mate with (1) the battery pack portion of the second interface and/or (2) the battery pack portion of the third interface. On an outside of the adaptor housing, the second battery pack adaptor 400b may include an equivalent of the battery pack portion of the fourth interface. This adaptor battery pack portion of the fourth interface may include a set of rails, a set of grooves, a terminal block and a latch. This adaptor battery pack portion of the fourth interface is designed and configured to mechanically and electrically mate with the power tool portion of the fourth interface. The second battery pack adaptor 400b may also include a lid or cap or door that encloses the third battery pack 200c within the second battery pack adaptor 400b. The housing and lid (when closed) may seal the third battery pack 200c from the environment outside the second battery pack adaptor 400b. This will protect the third battery pack 200c from debris and other contaminants, such as water.

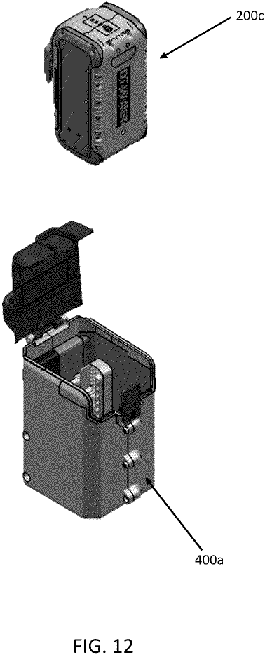

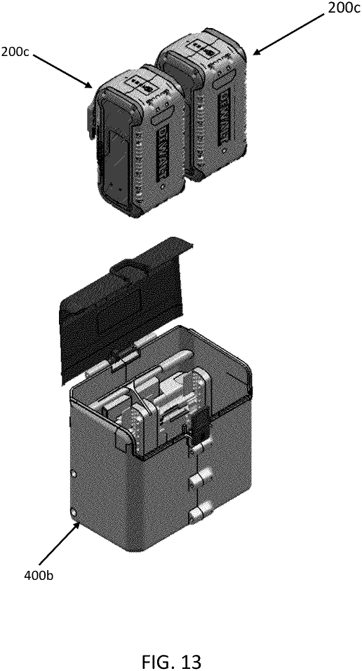

FIG. 12 illustrates the third battery pack 200c just prior to mating with the first battery pack adaptor 400a. FIG. 13 illustrates two of the third battery packs 200c just prior to mating with the second battery pack adaptor 400b.

By using the first battery pack adaptor 400a in combination with the third battery pack 200c or the second battery pack adaptor 400b in combination with two of the third battery packs 200c, or the fourth battery pack 200d, a user may select from a variety of power sources for the fourth power tool 100d.

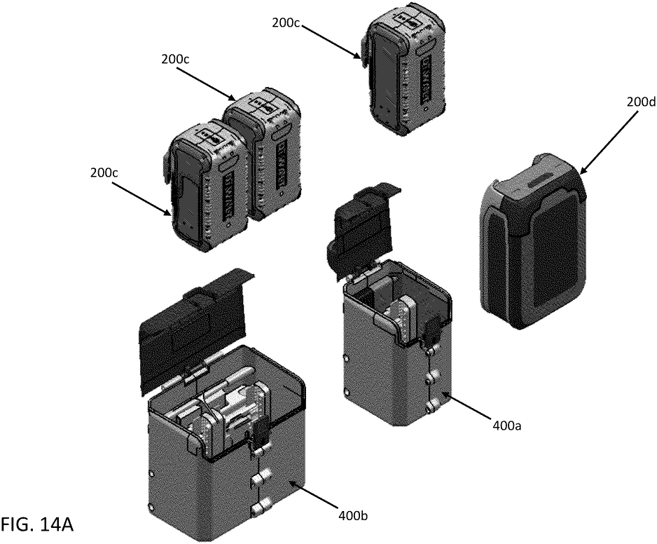

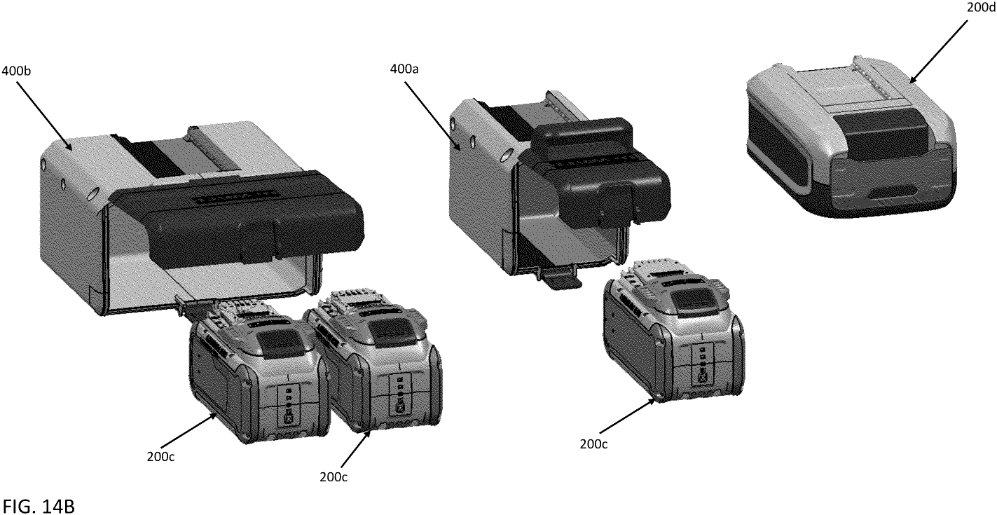

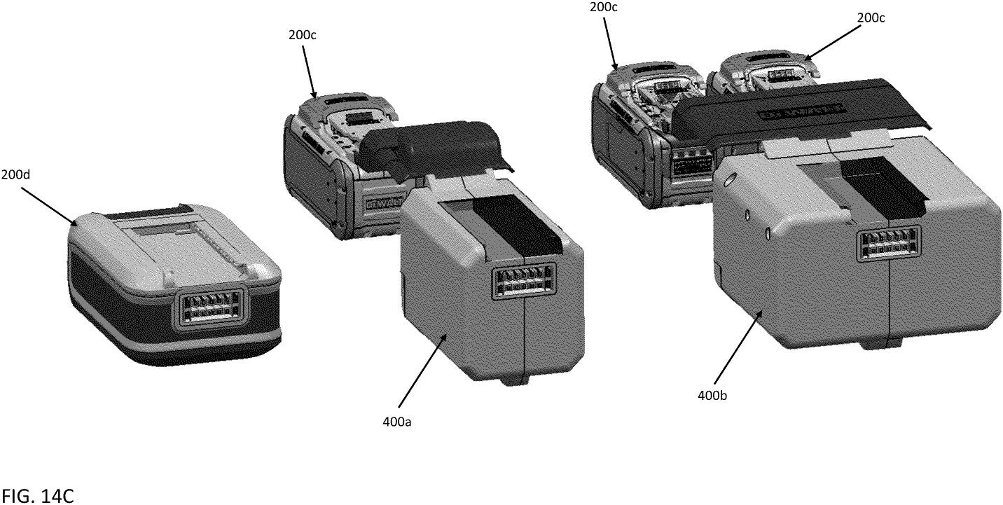

FIGS. 14A, 14B, and 14C illustrate different views of the fourth battery pack 200d, the first adaptor 400a and the second adaptor 400b, and several of the third battery packs 200c just prior to mating with the first adaptor 400a and the second adaptor 400b. As illustrated, the fourth battery pack 200d, the first adaptor 400a and the second adaptor 400b all include a battery pack portion of the fourth interface. This allows the fourth battery pack 200d, the first adaptor 400a and the second adaptor 400b to mate and operate with the fourth power tool 100d.

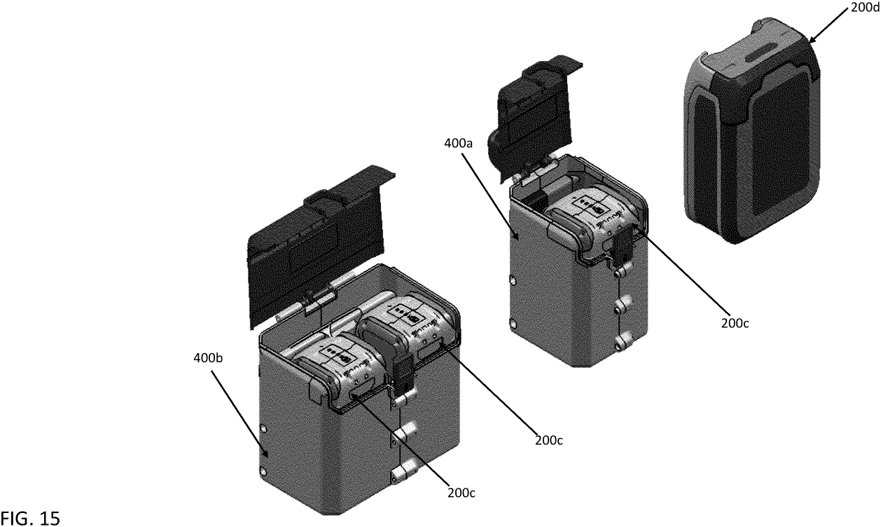

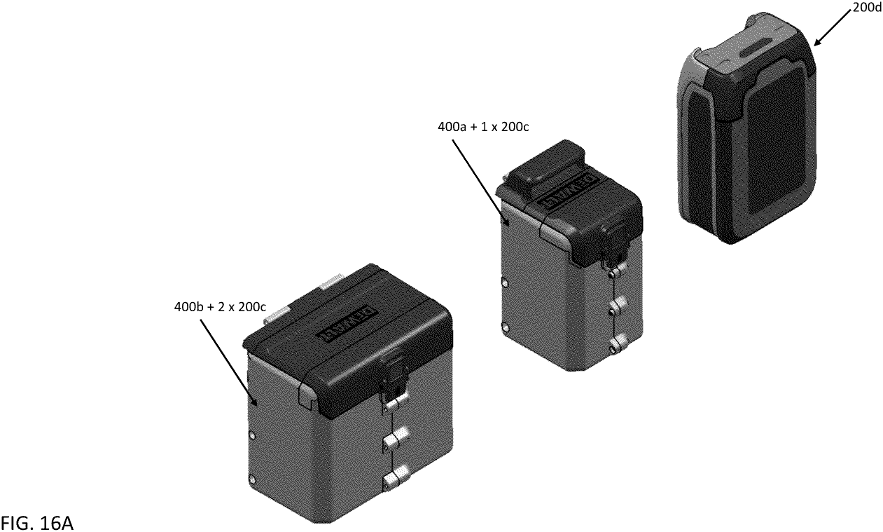

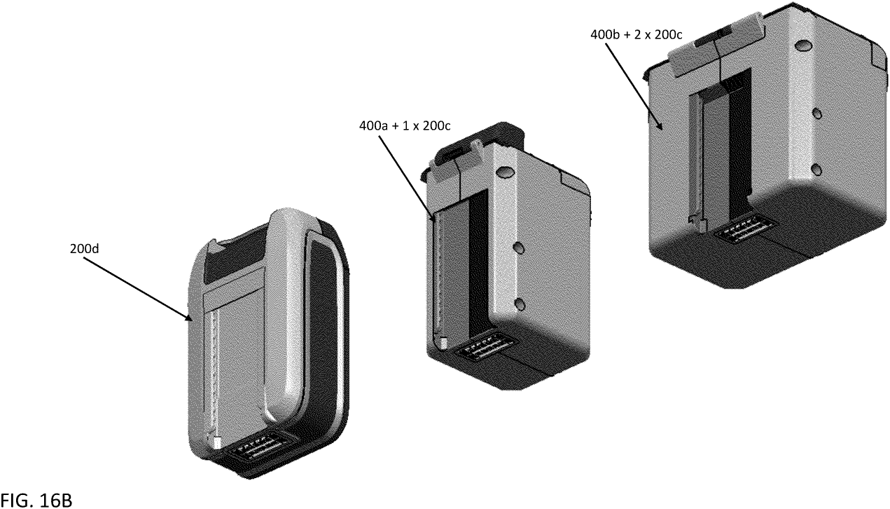

FIG. 15 illustrates the fourth battery pack 200d and the third battery packs 200c received in the first adaptor 400a and the second adaptor 400b. When the third battery packs 200c are received in the first adaptor 400a and the second adaptor 400b, the power tool portion of the third interface places the third battery packs 200c into the second, high voltage (e.g., 60V) mode. The second adaptor 400b may place (electrically connect) the two battery packs 200c in parallel.

FIGS. 16A and 16B illustrate the first adaptor 400a and the second adaptor 400b having the lid closed to seal and protect the third battery pack 200c.

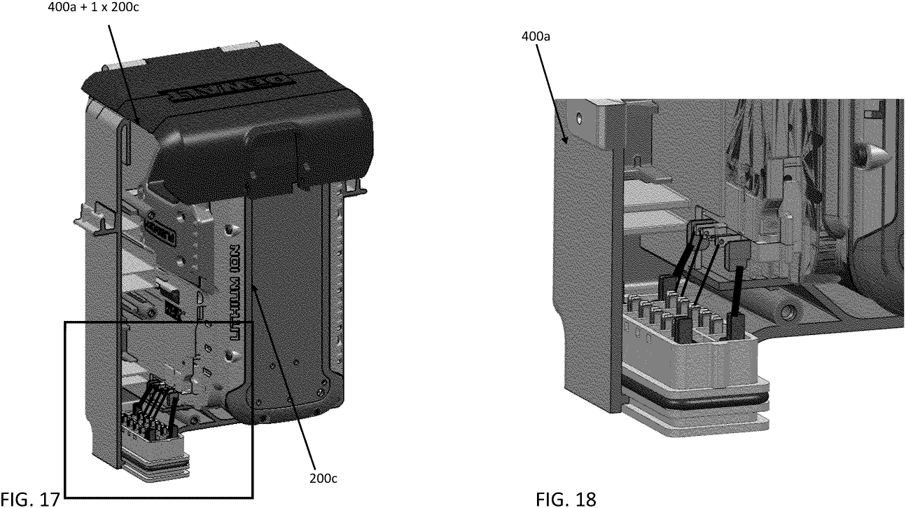

FIG. 17 illustrates a partial section view of the first battery pack adaptor 400a and the third battery pack 200c. As illustrated, the terminals of the terminal block of the power tool portion of the third interface are electrically connected to the terminals of the terminal block of the battery pack portion of the fourth interface. FIG. 18 illustrates a detail view of the electrical connections in the first batter pack adaptor 400a between the adaptor power tool portion of the third interface and the adaptor battery pack portion of the fourth interface. The adaptor power tool portion of the third interface is designed and configured to mechanically and electrically mate with the battery pack portion of the third interface and the adaptor battery pack portion of the fourth interface is designed and configured to mechanically and electrically mate with the power tool portion of the fourth interface.

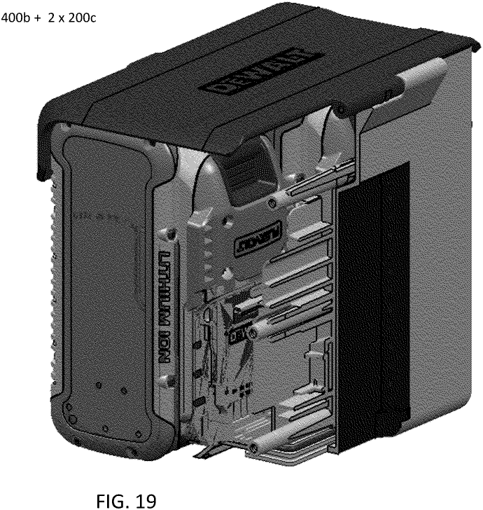

FIG. 19 illustrates a partial section view of the second battery pack adaptor 400a and two of the third battery packs 200c.

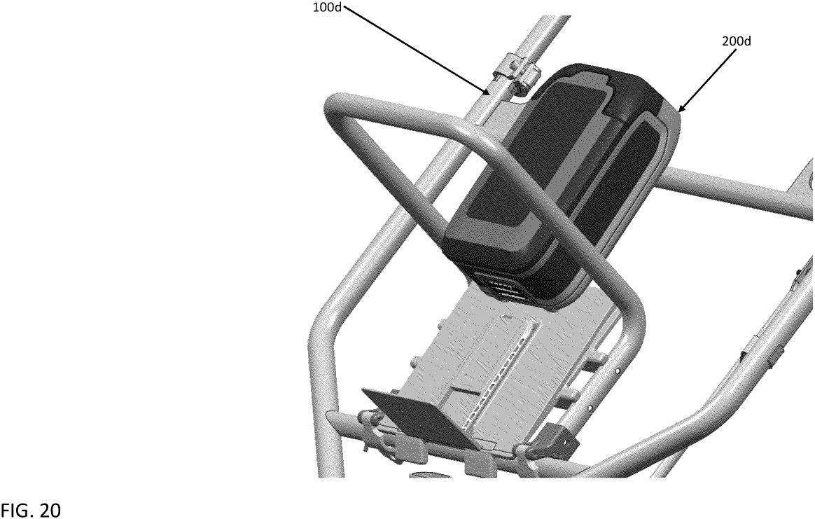

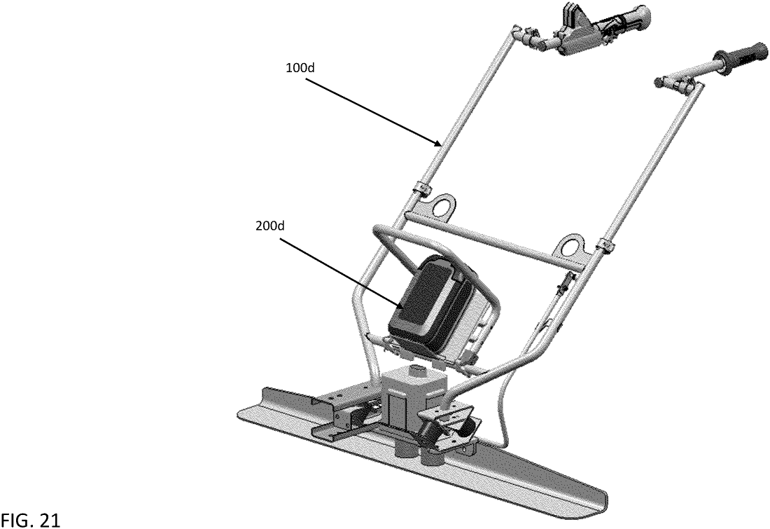

FIG. 20 illustrates the fourth battery pack 200d just prior to mating with the fourth power tool (e.g., a screed) 100d. The fourth power tool 100d may include the power tool portion of the fourth interface. The power tool portion of the fourth interface may include a set of rails, a set of grooves, a terminal block and a latch. The battery pack portion of the fourth interface is designed and configured to mechanically and electrically mate with the power tool portion of the fourth interface. FIG. 21 illustrates the fourth battery pack 200d mated with the fourth power tool 100d.

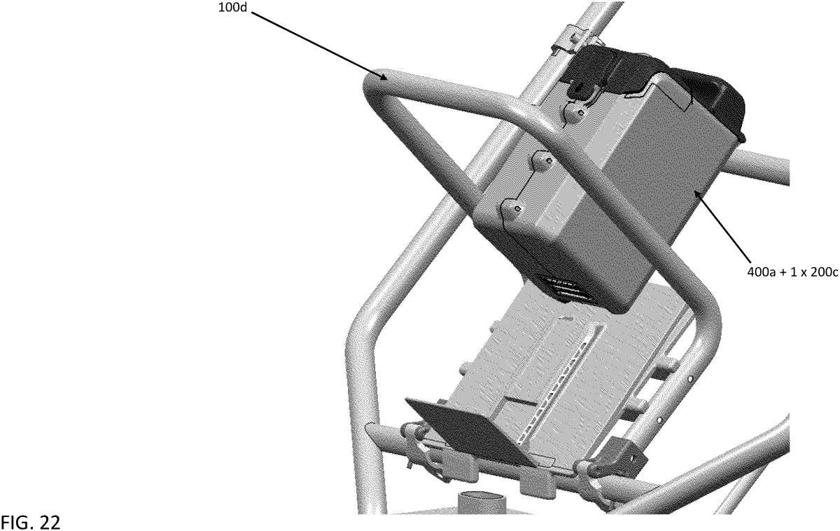

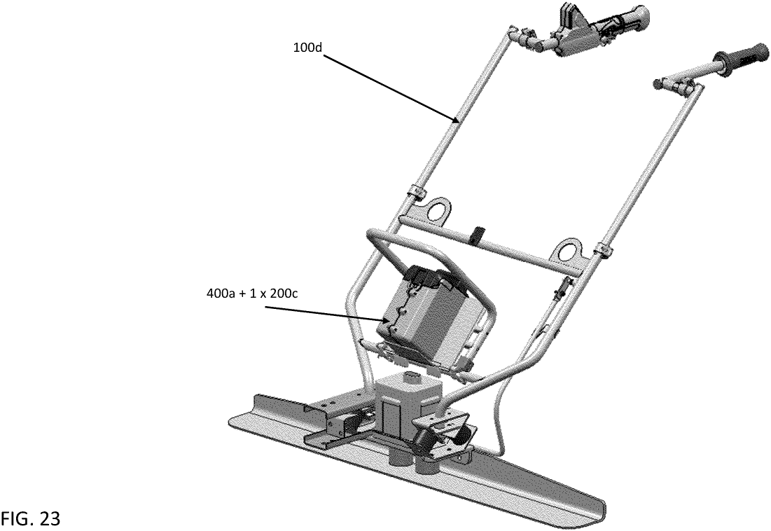

FIG. 22 illustrates the first battery pack adaptor 400a just prior to mating with the fourth power tool 100d. The adaptor battery pack portion of the fourth interface is designed and configured to mechanically and electrically mate with the power tool portion of the fourth interface. FIG. 23 illustrates the first battery pack adaptor 400a mated with the fourth power tool 100d.

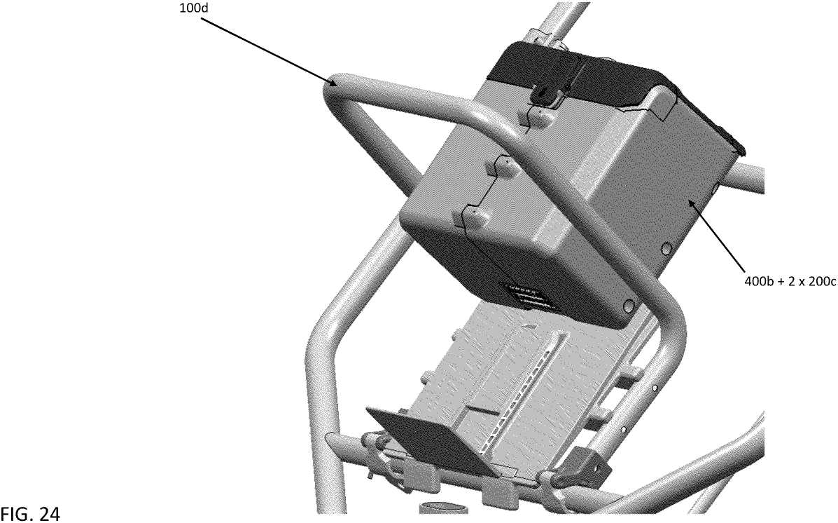

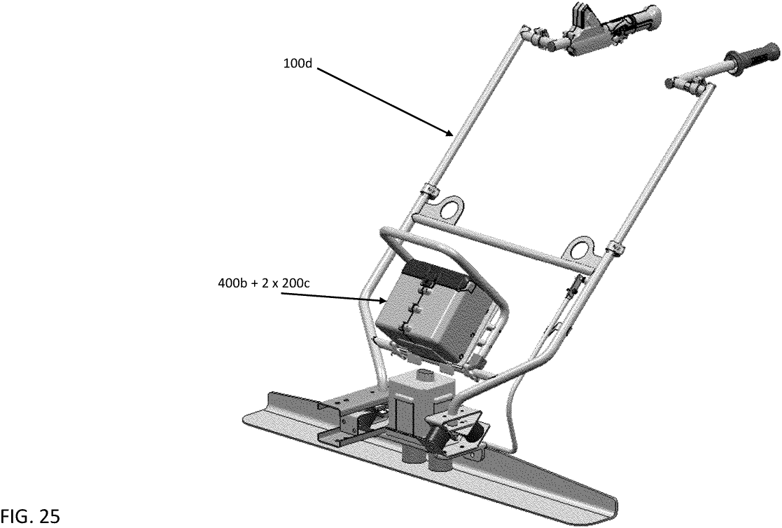

FIG. 24 illustrates the second battery pack adaptor 400b just prior to mating with the fourth power tool 100d. The battery pack portion of the fourth interface is designed and configured to mechanically and electrically mate with the power tool portion of the fourth interface. FIG. 25 illustrates the second battery pack adaptor 400b mated with the fourth power tool 100d.

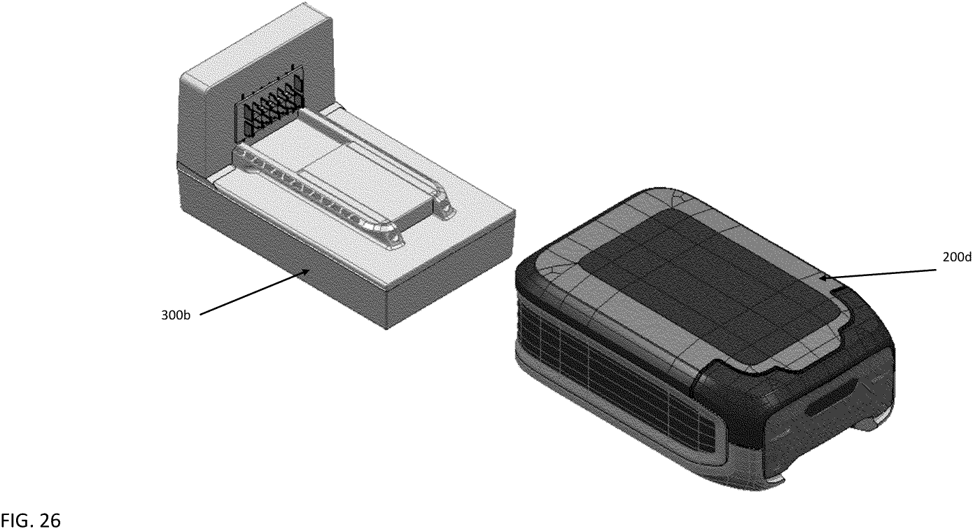

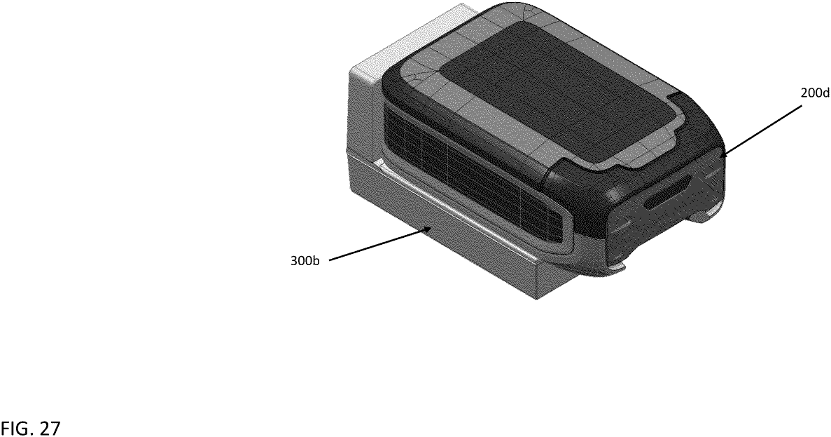

FIG. 26 illustrates the fourth battery pack 200d just prior to mating with an example second battery pack charger 300b. The second battery pack charger 300b may include the battery pack charger portion of the fourth interface. The battery pack charger portion of the fourth interface may include a set of rails, a set of grooves, a terminal block and a latch. The battery pack charger portion of the fourth interface is designed and configured to mechanically and electrically mate with the battery pack portion of the fourth interface. FIG. 27 illustrates the fourth battery pack 200d mated with the example second battery pack charger 300b. The battery pack charger 300b may charge the fourth battery pack 200d or the combination of the first battery pack adaptor 400a and the third battery pack 200c or the combination of the second battery pack adaptor 400c and the two third battery packs 200c to their rated voltage.

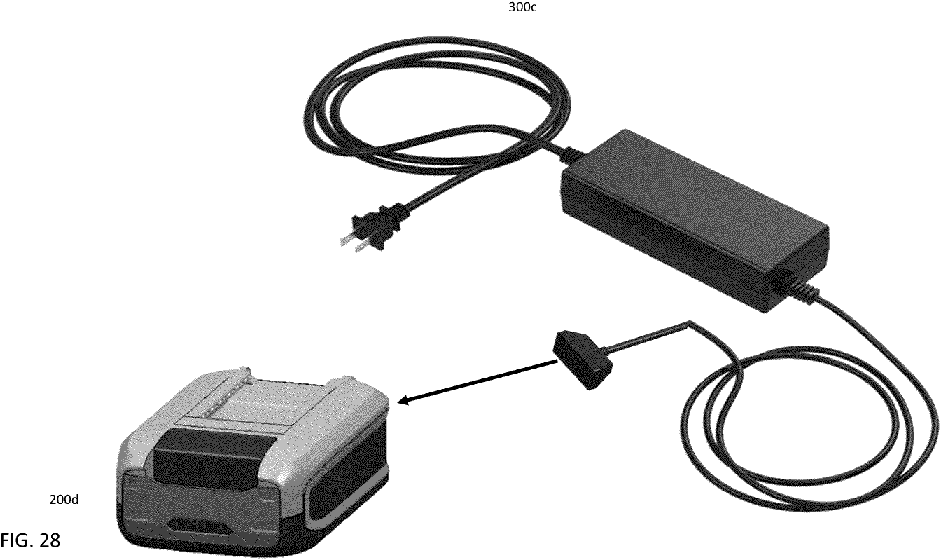

FIG. 28 illustrates the fourth battery pack 200d just prior to mating with an example third battery pack charger 300c. The third battery pack charger 300c may include a charger housing (commonly referred to as a brick) that houses various charger electronic components, an AC power cord attached at one end to the charger housing and having an AC power plug at0 another end, and a power supply cord attached at one end to the charger housing and having a connector having “a power tool portion” of the fourth interface necessary to mate with and provide power to the battery pack portion of the fourth interface on the example fourth battery pack 200d at another end.

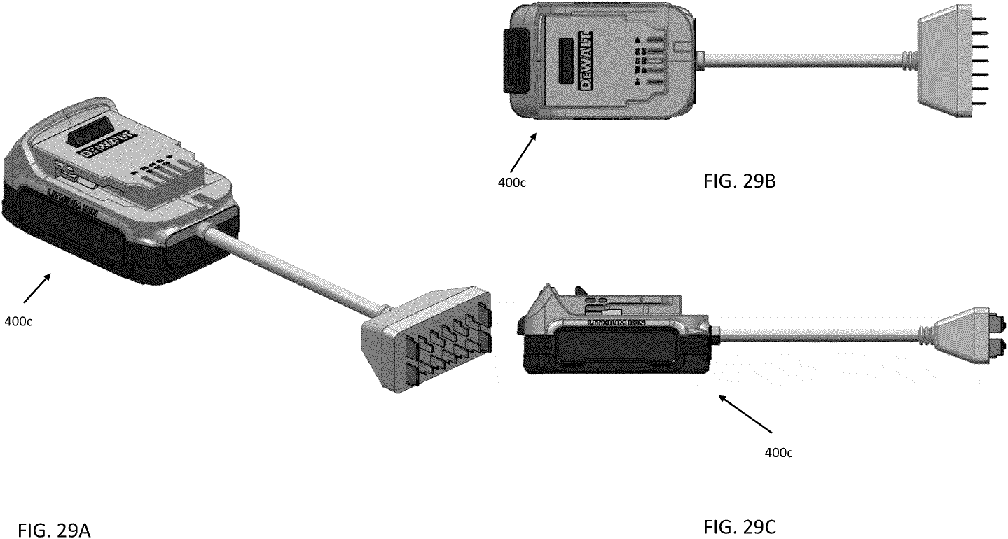

FIGS. 29A, 29B, and 29C illustrate a third example adaptor 400c. The third adaptor 400c may be used to provide power to a fourth battery pack 200d or a battery pack adaptor 400a, 400b from a battery pack charger 300a or provide power to a second power tool 100b or a third power tool 100c from a fourth battery pack 200d or a battery pack adaptor 400a, 400b. The third adaptor 400c may include a “dummy” portion that includes an equivalent to the battery pack portion of the first, second or third interface configured to mate with the battery pack charger portion of the first interface of the first battery pack charger 300a or the power tool portion of the second interface of the second power tool 100b or the power tool portion of the third interface of the third power tool 100c and a connector including a terminal block equivalent to the terminal block of the fourth interface and configured to mate with the terminal block of the battery pack portion of the fourth interface of the fourth battery pack 200d or the first battery pack adaptor 400a or the second battery pack adaptor 400b. An electrical cord connects the connector to the dummy portion of the charger adaptor.

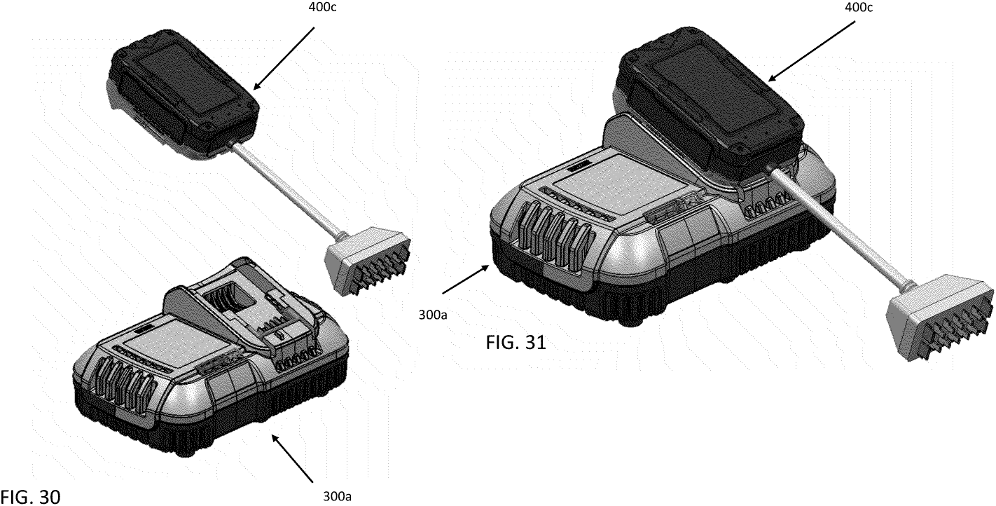

FIG. 30 illustrates the third adaptor 400c just prior to mating with the first battery pack charger 300a. The battery pack charger 300a includes the battery pack charger portion of the first interface, the second interface or the third interface. The battery pack charger portion of the interface is configured and designed to mate with the battery pack portion of the corresponding interface. FIG. 31 illustrates the third adaptor 400c mated to the first battery pack charger 300a. This embodiment allows users to charge the fourth battery pack 400d and/or the adaptors 400a, 400b (actually the battery packs 200b, 200c in the corresponding adaptor 400a, 400b) having the battery pack portion of the fourth interface with a battery pack charger having the battery pack charger portion of the first interface, the second interface or the third interface.

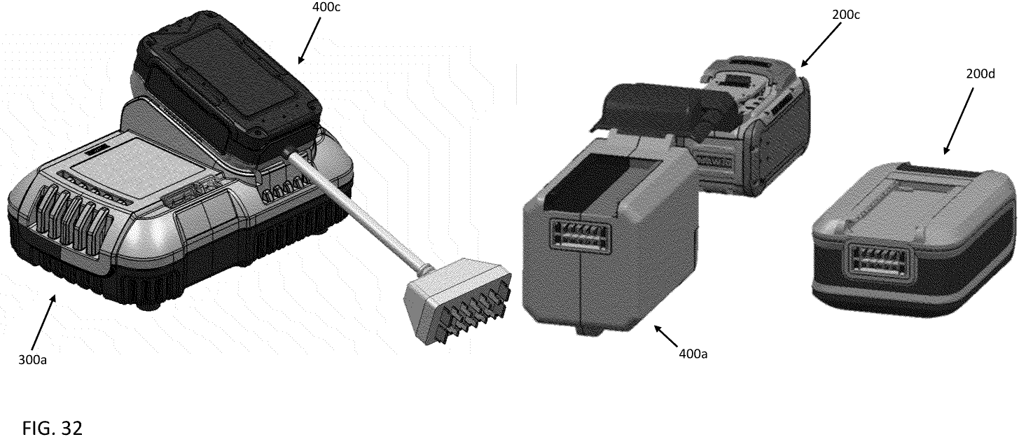

As illustrated in FIG. 32, the third adaptor 400c enables the first battery pack charger 300a to charge the fourth battery pack 200d or the third battery pack 200c through the first battery pack adaptor 400a.

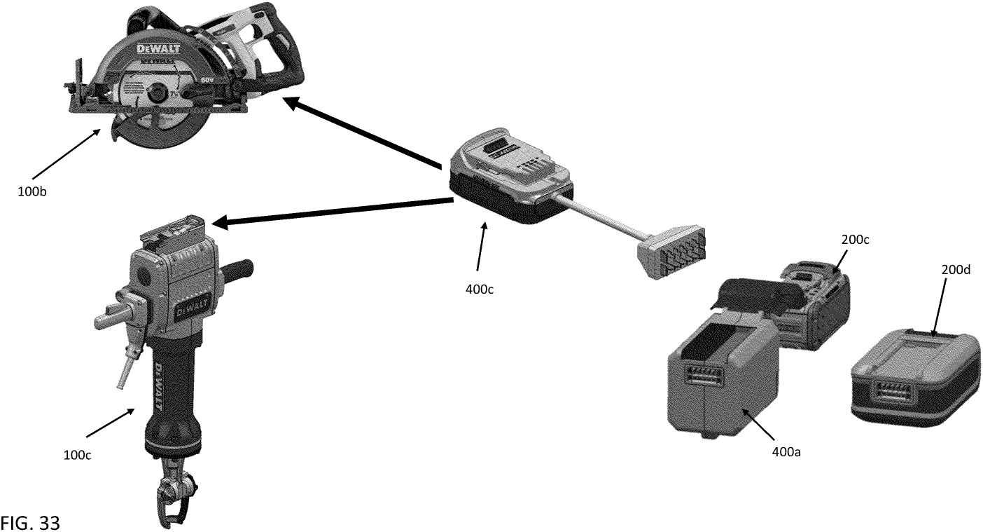

As illustrated in FIG. 33, the third adaptor 400c enables the fourth battery pack 200d or the combination of the third battery pack 200c and the first battery pack adaptor 400a to provide power to the second power tool 100b or the third power tool 100c. In this embodiment, the dummy pack couples to the tool portion of the second interface of the second power tool 100b or the tool portion of the third interface of the third power tool 100c. In addition, the connector couples to the battery pack portion of the fourth interface on the fourth battery pack 200d or the adaptor battery pack portion of the fourth interface on the first adaptor 400a.

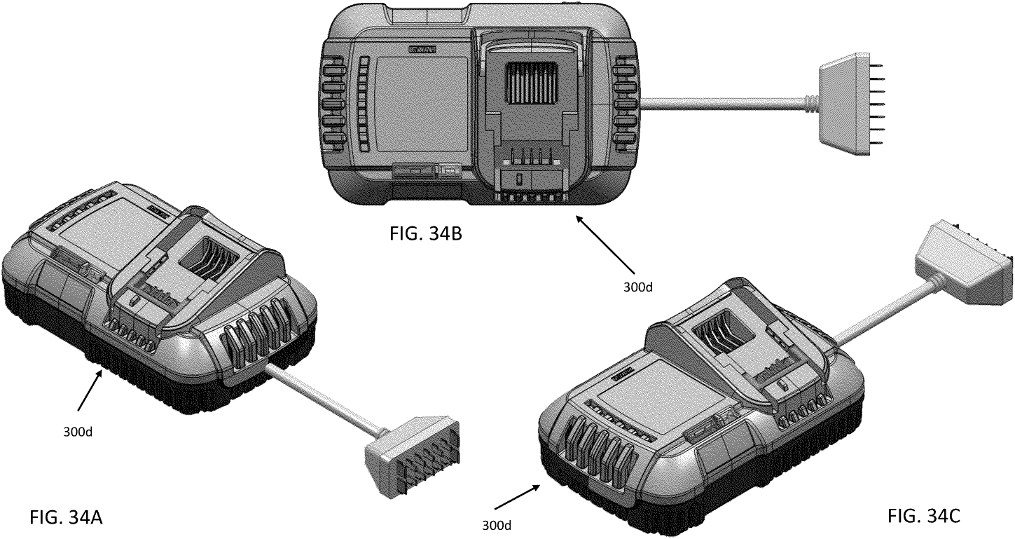

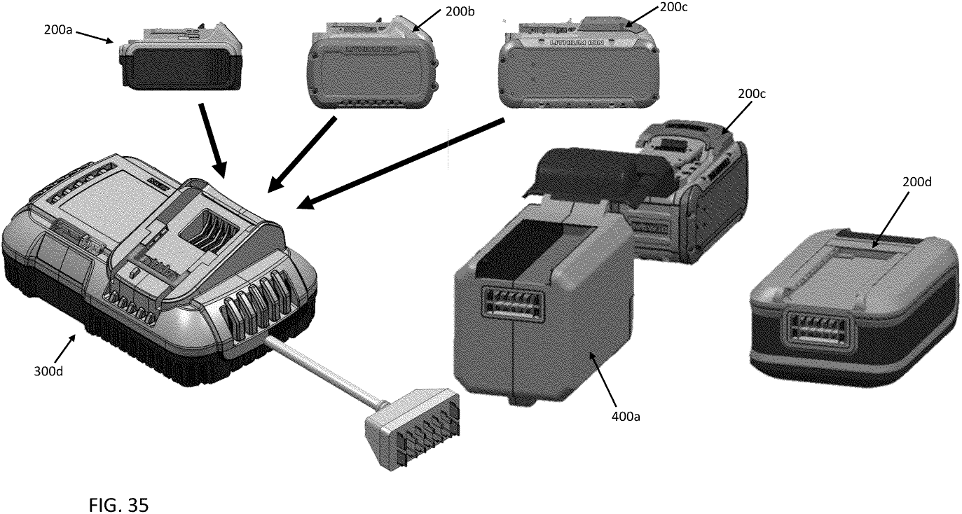

FIGS. 34A, 34B, and 34C illustrate an example fourth battery pack charger 300d. The fourth battery pack charger 300d may include a base portion. The base portion may include a receptacle for receiving one of the first battery pack 200a, the second battery pack 200b or the third battery pack 200c. The receptacle may include a battery pack charger portion of the first interface, of the second interface, or of the third interface configured to mate with the battery pack portion of the corresponding first interface, second interface or third interface. The battery pack charger may also include a connector configured to mate with the terminal block of the battery pack portion of the fourth interface of the fourth battery pack 200d and/or the terminal block of the adaptor battery pack portion of the fourth interface of the combination of the battery pack adaptor 400a and the third battery pack 200c. An electrical cord connects the connector to the base portion of the fourth battery pack charger 300d. As illustrated in FIG. 35, this example configuration enables the battery pack charger 300d, capable of charging to a charger set point of 60V, for example, to charge the first battery pack 200a, the second battery pack 200b or the third battery pack 200c via the receptable of the base portion and/or the fourth battery pack 200d, the first adaptor 400a/third battery pack 200c or the second adaptor 400b/two third battery packs 200c via the electrical cord and the connector. The battery pack charger 300d may provide charging current to the base receptable and the connector simultaneously or sequentially. The battery pack charger portion of the second interface and the third interface are designed and configured to mechanically and electrically mate with the battery pack portion of the second interface and the third interface, respectively. The terminal block of the power tool portion of the fourth interface is designed and configured to mechanically and electrically mate with the battery pack portion of the fourth interface.

FIG. 36 illustrates an example fifth battery pack charger 300e for charging the fourth battery pack 200d and/or the combination of the first battery pack adaptor 400a and the third battery pack 200c from an example high speed electric vehicle (EV) charging station. The fifth battery pack charger 300e may include a “brick” configuration as noted above. The fifth battery pack charger 300e may include a power cord attached at one end to the charger housing and having an EV power plug/EV connector receptacle at another end configured to mate with a connector of an EV power cord/EV connector plug of the EV charging station, and a power supply cord attached at one end to the charger housing and having a connector having “a power tool portion” of the fourth interface that will mate with the battery pack portion of the fourth interface on the example fourth battery pack 200d at another end.

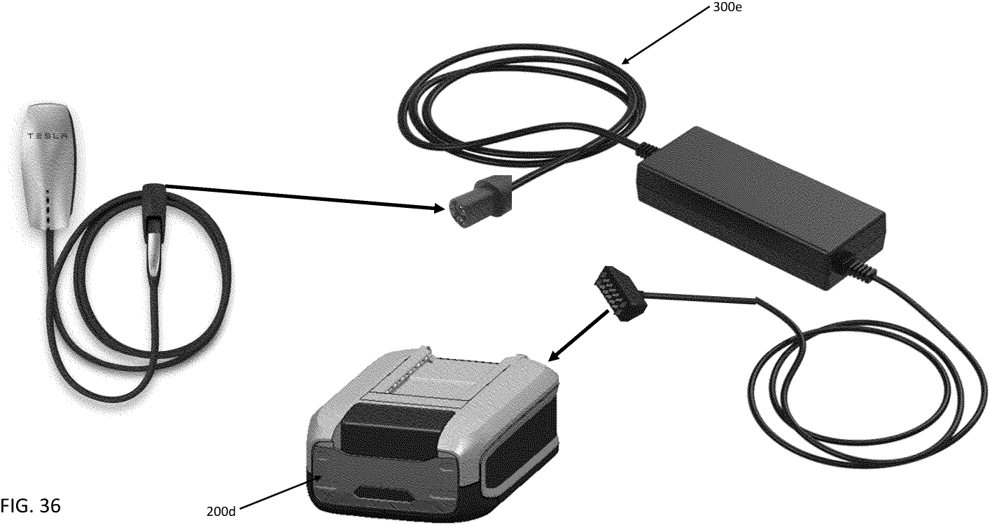

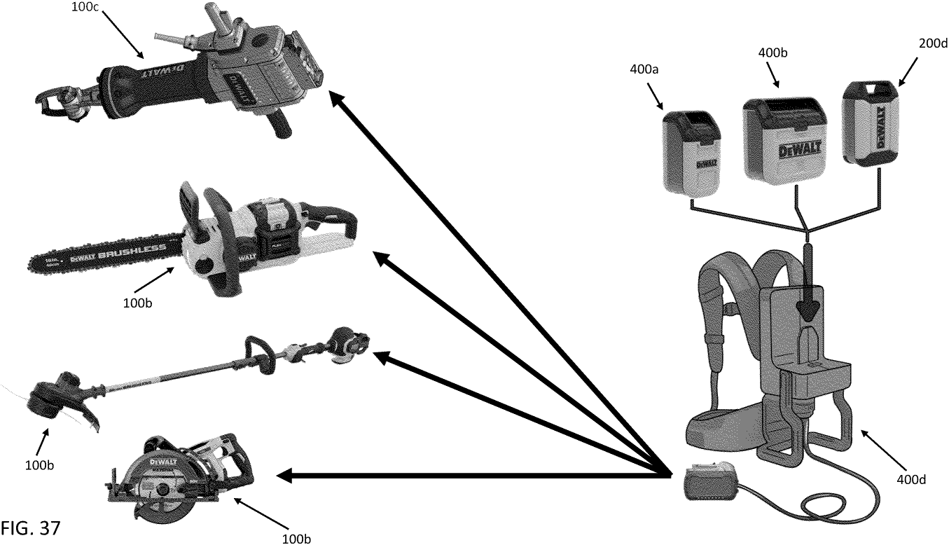

FIG. 37 illustrates a fourth example adaptor 400. The fourth adaptor is in the form of a backpack adaptor 400d. The backpack adaptor 400d may include a harness for supporting the adaptor 400d on a user’s back. The harness may include an electronics housing for housing electronic components for transferring power to and/or from an attached battery pack 200d and/or a combination of a first adaptor 400a and a third battery pack 200c and/or a combination of a second adaptor 400b and two third battery packs 200c and communications signals to and/or from an attached battery pack 200d and/or adaptor 400a or 400b. The backpack adaptor 400d may include a power tool portion of the fourth interface to mate with the battery pack portion of the fourth interface of the fourth battery pack 200d and/or the battery pack adaptors 400a, 400b. The backpack adaptor 400d may also include a dummy battery pack coupled to the electronics housing by a cord. The dummy battery pack may include the battery pack portion of the second interface and/or the third interface enabling the dummy battery pack to mate with various power tools of the set of second power tools 100b and/or the set of third power tools 100c. As such, the fourth battery pack 200d and/or the battery pack adaptors 400a, 400b may provide power to the various power tools of the second set of power tools 100b and/or the set of third power tools 100c. The backpack adaptor 400d, when coupled to the fourth battery pack 200d or the adaptor 400a, 400b can provide additional runtime when coupled to the second power tool 100b or the third power tool 100c while also provide reduced weight to be carried by user’s hand holding one of the second power tool 100b or the third power tool 100c.

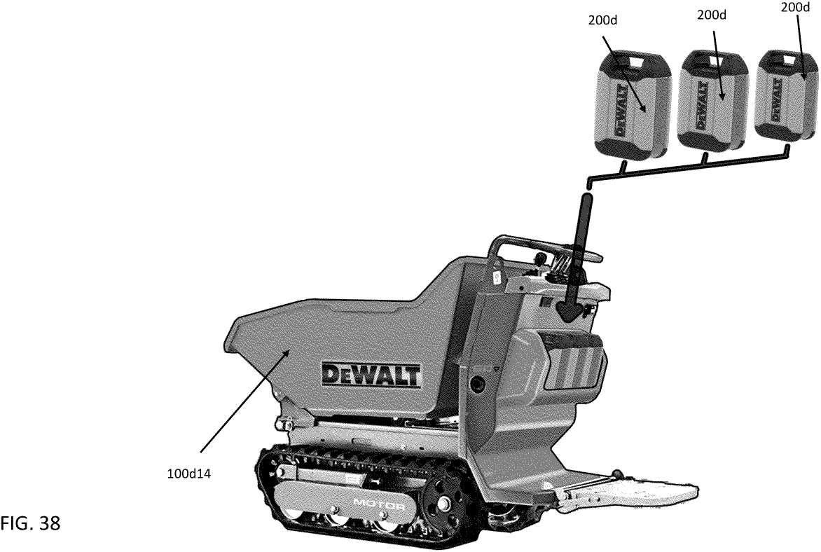

FIG. 38 illustrates an example jobsite buggy or motorize barrow 100d14 and a plurality of the fourth battery packs 200d. The plurality of battery packs 200d may be coupled to the buggy 100d14 to provide power. The battery packs 200d may be connected in parallel to provide extended runtime and power for the buggy 100d14. The buggy 100d14 may include a plurality of receptacles. Each receptacle is configured to receive one of the fourth battery packs 200d. Each receptacle will include a “power tool portion” of the fourth interface - same as power tool portion of fourth interface - that mates with the battery pack portion of the fourth interface.

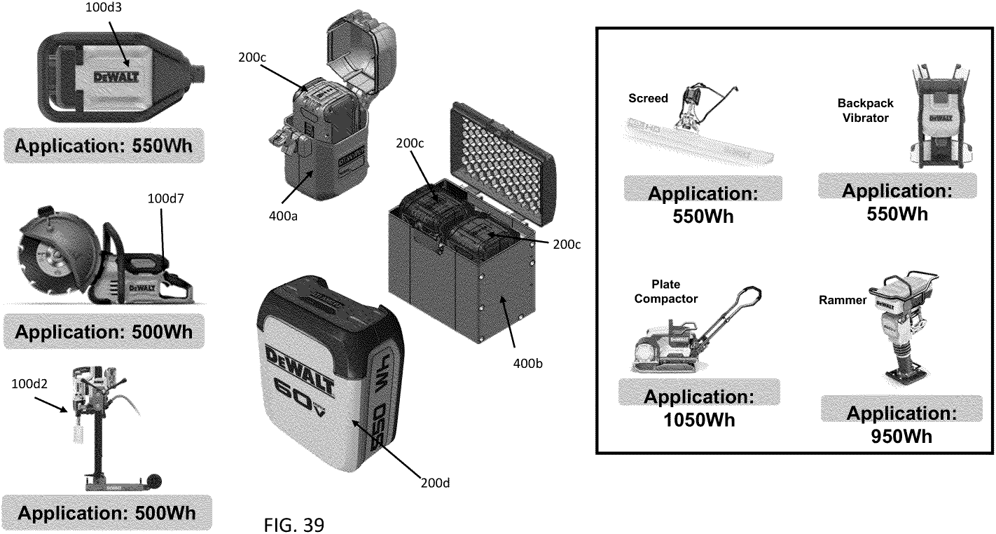

FIG. 39 illustrates alternate example battery pack adaptors, both a 1X and 2X adaptor. Similar to the battery pack adaptors described above, the example battery adaptors include a “battery pack” portion of the fourth interface substantially identical to the battery pack portion of the fourth interface on the fourth battery pack 200d. FIG. 39 also illustrates additional example power tools 100d including the power tool portion of the fourth interface enabling these tools 100d to mate with and receive power from any of the fourth battery pack 200d or the battery pack adaptors 400a, 400b.

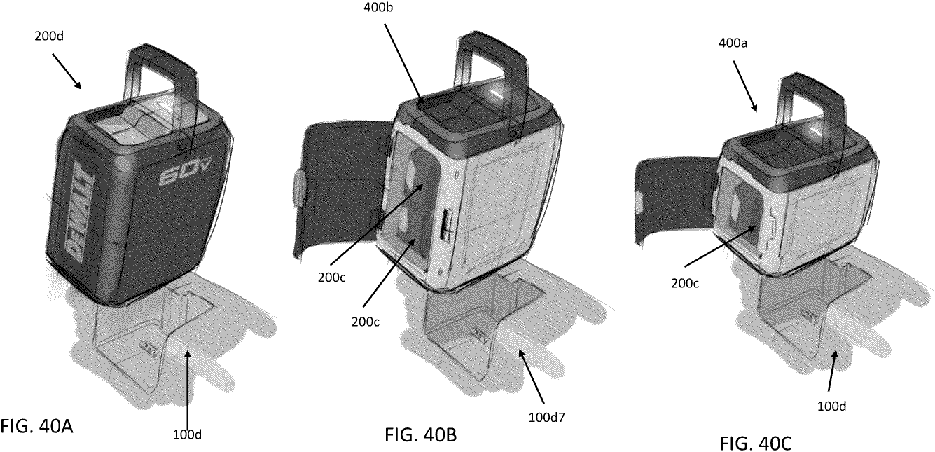

FIG. 40A illustrates another example power tool 100d having another example power tool interface of a battery pack/power tool interface and another example single voltage battery pack 200d having another example battery pack interface of the battery pack/power tool interface. FIG. 40B illustrates the example power tool 100d and another example 2X battery pack adaptor 400b having the example battery pack interface of the battery pack/power tool interface. FIG. 40C illustrates the example power tool 100d and another example 1X battery pack adaptor 400a having the example battery pack interface of the battery pack/power tool interface.

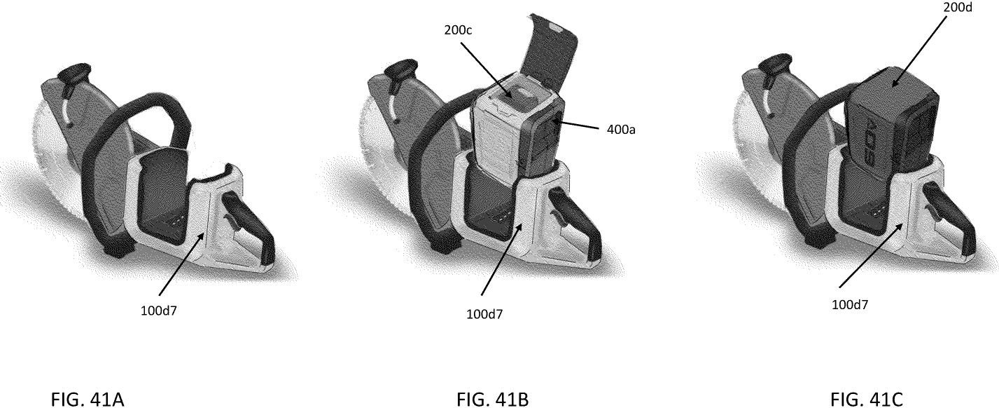

FIG. 41A illustrates an alternate example of a power tool 100d7 including an example embodiment of a power tool interface of a battery pack/power tool interface. FIG. 41B illustrates the example power tool 100d7 having the example power tool interface of the battery pack/power tool interface and another example 1X battery pack adaptor 200c having the example battery pack interface portion of the battery pack/power tool interface. FIG. 41C illustrates the example power tool 100d7 having the example power tool interface of the battery pack/power tool interface and an example single voltage battery pack 200d having another example battery pack interface of the battery pack/power tool interface.

In one example embodiment of the present invention a high voltage, high power battery pack 200d includes a battery pack portion of a interface and a high voltage, high power power tool includes a power tool portion of the interface. The high voltage battery pack 200d is configured to mate with and provide power to the power tool 100d7. The high voltage, high power power tool 100d7 is configured to mate with and receive power from the high voltage, high power battery pack 200d. The battery pack portion of the interface is configured to mate with the power tool portion of the interface. The power tool portion of the interface is configured to mate with the battery pack portion of the interface. The power tool portion of the interface may include (a) a terminal block including a housing and a set of power tool terminals, (b) a set of rails and grooves and (c) a latching arrangement. The battery pack portion of the interface may include (a) a terminal block including a housing and a set of battery pack terminals, (b) a set of rails and grooves and (c) a latching arrangement.

The example embodiment of the present invention may also include a high voltage, low power battery pack 200c having a battery pack portion of an interface that is configured to mate with a power tool portion of the interface of the high voltage, low power power tools 100c. The battery pack portion of the interface of the high voltage, low power battery pack 200c is unable to mate with the power tool portion of the interface of the high voltage, high power power tool 100d (therefore the high voltage, low power battery packs are unable to mate with the high voltage, high power power tools and provide power to the high voltage, high power power tools).

The example embodiment of the present invention may also include an adaptor 400a to enable the high voltage, low power battery packs 200c to provide power to the high voltage, high power power tools 100d. The adaptor 400a has a first interface portion and a second interface portion. The first interface portion is electrically coupled to the second interface portion. The first interface portion is the same as the battery pack portion of the interface of the high voltage, high power power tool 100d. The second interface portion is the same as the power tool portion of the interface of the high voltage, low power battery pack 200c.

The adaptor 400a may couple to/mate with (house) one, two, or more high voltage, low power battery packs 200c, e.g., multi-voltage battery packs. The second interface portion - the power tool portion of the interface of the high voltage, low power battery pack 200c enables the adaptor to mate with the high voltage, low power battery packs 200c. The first interface portion - the battery pack portion of the interface (1) enables the adaptor 400a to mate with the tool portion of the interface of the high voltage, high power power tool 100d and (2) is the same as a pack portion of the interface of the high voltage, high power battery packs 200d. This enables the high voltage, high power battery pack 200d (directly) and the high voltage, low power battery pack 200c (through the adaptor) to provide power to the high voltage, high power power tool 100d.

An battery pack platform is designed around a common interface including a set of terminals, a set of rails, and a latch.

The objective is to preserve compatibility between existing products (power tools, battery packs, and battery pack chargers) and new tools/packs/chargers across DeWalt’s platform.

As new tools that demand higher currents and longer runtimes are developed, corresponding new, larger and more powerful battery packs must also be developed. An important feature of the new tools and packs is to preserve compatibility across the an existing platform where it is needed while preserving the ergonomics of the new products.

Adaptors housing one, two, or more multi-voltage battery packs having with a new “pack” interface that enables the adaptor to mate with new tools and is the same as an interface of new battery packs that enables the new battery packs to mate with the new tools.

Additionally, this could reduce weight and size of the tools by using the new pack OR the adaptor as a structural element.

A new interface - including a new tool terminal block and terminals, rails and latch and a new pack terminal block and terminals, rails and a new latching arrangement -would allow the adaptor to be removed and replaced with new larger, heavier, and more powerful battery packs.

The foregoing description illustrates the claimed invention by way of example and not by way of limitation. The description clearly enables one skilled in the art to make and use the disclosure, describes several example embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other example embodiments and of being practiced or being carried out in various ways. Also, it is to be understood that the phraseology and terminology used herein is for the purpose of description and should not be regarded as limiting.

Some of the techniques described herein may be implemented by one or more computer programs executed by one or more processors residing, for example on a power tool. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The foregoing description of the example embodiments has been provided for purposes of illustration and description. It is not intended to be exhaustive or to limit the disclosure. Individual elements or features of a particular example embodiment are generally not limited to that particular example embodiment, but, where applicable, are interchangeable and can be used in a selected example embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of example embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Numerous modifications may be made to the exemplary implementations described above. These and other implementations are within the scope of this application.

1. A power tool system, comprising:
a first power tool including a first power tool interface;
a second power tool including a second power tool interface, the second power tool interface being different that the first power tool interface;
a first battery pack including a first battery pack interface configured to mate with the first power tool interface and to not mate with the second power tool interface;
a second battery pack including a second battery pack interface configured to mate with the second power tool interface and to not mate with the first power tool interface; and
an adaptor, the adaptor including a housing defining an internal cavity, the housing including a movable door to provide access to the internal cavity, a first adaptor interface positioned in the internal cavity configured to mate with the first battery pack interface, a second adaptor interface positioned on an exterior of the housing to mate with the second power tool interface.
